(19) United States
(12) Patent Application Publication
(10) Pub. No.: US 2021/0402850 A1
(43) Pub. Date: Dec. 30, 2021

(54) RADIANT PANEL INTENDED FOR INSTALLATION INSIDE A VEHICLE PASSENGER COMPARTMENT

(71) Applicant: Valeo Systemes Thermiques, Le Mesnil Saint-Denis (FR)

(72) Inventors: Nicolas Devienne, Le Mesnil Saint Denis (FR); Franck Martin, Le Mesnil Saint Denis (FR); Laurine Elena, Le Mesnil Saint Denis (FR); Vania-Daniela Hernandez-Bello, Le Mesnil Saint Denis (FR); Georges De Pelsemaeker, Le Mesnil Saint-Denis (FR)

(73) Assignee: Valeo Systemes Thermiques, Le Mesnil Saint-Denis (FR)

(21) Appl. No.: 17/279,292

(22) PCT Filed: Sep. 23, 2019
(86) PCT No.: PCT/FR2019/052223

§ 371 Date: Mar. 24, 2021

(30) Foreign Application Priority Data
Sep. 29, 2018 (FR) 1858821

(51) Int. Cl. B60H 1/22; F24H 3/04; H05B 3/34

(52) U.S. Cl. CPC B60H 1/2227; F24H 3/0447; B60H 1/2218; B60H 1/2226; H05B 3/34

(57) ABSTRACT

A radiant panel (1) intended to be installed inside a vehicle (80) passenger compartment (3), in particular a motor vehicle passenger compartment, the radiant panel (1) comprising at least one array of electrodes with at least two primary electrodes of different polarities, the array of electrodes being arranged such that at least two primary electrodes of different polarities each define at least one spiral winding around one another.

The field of the present invention relates to devices for heating a vehicle passenger compartment, in particular a motor vehicle passenger compartment, and more particularly to radiant panels installed inside such a passenger compartment.

A radiant panel is a device that generally comprises an electrical circuit configured so as to deliver heat through the Joule effect by supplying electric current to resistive conductive elements. These may be wire elements or surface coatings. According to the existing literature, the conductive coating may be for example a layer of paint comprising carbon particles and/or metal particles.

One problem that arises nowadays is the difficulty of achieving uniform heating over the entire surface of the radiant panel, that is to say a heating temperature that does not vary from one point to another on the surface of the radiant panel. This drawback is exacerbated by geometric constraints, since the radiant panel is intended to be arranged in various parts of the passenger compartment (roof, door, pillar, glove box, etc.).

There are currently many heating technologies involving radiant panels. Some manufacturers use wired technology, but heat is produced in a non-uniform manner. To overcome this problem, some manufacturers offer a surface technology that consists in depositing a partially resistive conductive material between two electrodes. The thermal power created through the Joule effect depends on the supply voltage U and on the electrical resistance R between the two electrodes, and satisfies the following law: P=U²/R. Since the resistance R is proportional to the distance d between the two electrodes, it is necessary to arrange the two electrodes at a constant distance from one another in order to achieve uniform radiative thermal power (and therefore uniform thermal comfort) over the entire surface of the radiant panel. Furthermore, the thickness and the quality of the conductive material should be uniform over the entire surface of the radiant panel. The prior art mentions two configurations:

In a first configuration, the two electrodes are planar and arranged in planes parallel to one another and separated by a small distance. The resistive material is arranged between the planes formed by the two electrodes. This design suffers from one major drawback: a short circuit may occur in the event of unexpected contact between the two electrodes, in particular upon accidental pinching of the resistive material between the two electrodes. Such a radiant panel is therefore particularly unsuitable for the automotive industry, which imposes safety requirements.

In a second configuration, a partially resistive conductive material is stretched between two elongate electrodes, so as to form a heating surface. The two electrodes supply electric current to said material, which will then emit heat through the Joule effect. The heating surface is conventionally in the shape of a rectangle having two short sides and two long sides, the two electrodes being arranged along the longer sides. This geometric constraint may make it complicated to integrate the radiant panel into various parts of the passenger compartment. Another constraint that should be taken into account is that, at low voltages, the distance between two electrodes is limited by the maximum thicknesses of conductive material, which are themselves defined by mechanical, process, weight and packaging constraints.

In order to guarantee a constant heating power flux density, it is also necessary to limit or even compensate for the voltage losses across the terminals of the electrodes caused by the Joule effect. Two solutions are well known to a person skilled in the art: reducing the length of the electrodes or increasing their cross section. However, the variation in the cross section of the electrodes is limited by visual or haptic constraints. The electrodes should not adversely affect the design and the quality of the decorative elements bearing them.

The present invention aims to propose a radiant panel, intended to be fitted in a vehicle, in particular a motor vehicle, which overcomes the abovementioned geometric and thermal constraints.

One subject of the invention is a radiant panel intended to be installed inside a vehicle passenger compartment, in particular a motor vehicle passenger compartment, the radiant panel comprising at least one array of electrodes with at least two primary electrodes of different polarities, the array of electrodes being arranged such that at least two primary electrodes of different polarities each define at least one spiral winding around one another.

According to one or more features that may be implemented alone or in combination, there may be provision for the following:
there are two primary electrodes,
the primary electrodes each define a single spiral,
the primary electrodes each define multiple spirals,
the center of at least one spiral is located substantially in the center of the radiant panel,
at least one spiral has at least a number n of straight segments per turn around the radiant panel,
the number n may be equal to 3, 4, 5, 6, or more,
the spirals have the same total number of straight segments,
the spirals have a different total number of straight segments,
the angle α between two consecutive straight segments is less than 90°, greater than 90° or equal to 90°,
the distance D measured between a straight segment belonging to the primary electrode and an adjacent straight segment belonging to the primary electrode of opposite polarity is constant along the primary electrodes,
the distance D measured between a straight segment belonging to the primary electrode and an adjacent straight segment belonging to the primary electrode of opposite polarity is variable along the primary electrodes,
the distance D′ measured between two parallel and consecutive straight segments belonging to the same primary electrode is constant along the primary electrodes,
the distance D′ measured between two parallel and consecutive straight segments belonging to the same primary electrode is variable along the primary electrodes,
at least one spiral has at least a number m of substantially curved portions,
the number m may be equal to 1, 2, 3, or more,
the spirals have the same number m of substantially curved portions,
the spirals are formed, over their entire length, of straight segments,
the spirals are formed, over their entire length, of substantially curved portions,
at least one spiral has turns equidistant from one another over at least part of the length of said spiral,
at least one spiral has turns equidistant from one another over the entire length of said spiral,
at least one spiral has turns at a variable distance d from one another over at least part of the length of said spiral,
the distance d increases moving away from the center of the spiral,
the distance d decreases moving away from the center of the spiral,
at least two primary electrodes of different polarities are equidistant from one another over at least part of their length,
at least two primary electrodes of different polarities are equidistant from one another over their entire length,
at least two primary electrodes of different polarities are at a variable distance from one another over at least part of their length,
at least two primary electrodes of different polarities are at a variable distance from one another over their entire length,
the primary electrodes of different polarities are connected to an electric power supply at each of their ends,
at least one of the primary electrodes comprises at least one dissipating branch, in particular a plurality of dissipating branches, designed to produce electric current that flows between said dissipating branch and at least one primary electrode of different polarity,
at least one of the primary electrodes comprises a plurality of dissipating branches of the same polarity,
the dissipating branches are arranged substantially perpendicular to the primary electrodes of the same polarity to which they are attached,
at least one of the dissipating branches of the at least one primary electrode is arranged between two neighboring dissipating branches of the at least one primary electrode of different polarity, such that the electric current is able to be established between the dissipating branch of the at least one primary electrode and the two neighboring dissipating branches of the at least one primary electrode of different polarity,
the dissipating branches are spaced regularly along the primary electrode of the same polarity to which they are attached,
the dissipating branches are spaced apart by a variable distance L′ along the primary electrode of the same polarity to which they are attached,
at least one of the primary electrodes has a variable cross section over at least part of its length,
at least one of the primary electrodes has a constant cross section over its entire length,
the primary electrodes of different polarities have different cross sections,
the primary electrodes of different polarities have identical cross sections,
the dissipating branches have a variable cross section over their length,
the dissipating branches have a constant cross section over their length,
the dissipating branches of different polarities have identical or different cross sections,
the dissipating branches of identical polarities have identical or different cross sections,
the at least two primary electrodes are connected to an electrical supply network of the vehicle,
the radiant panel comprises a support covered with a partially resistive conductive material into which the array of electrodes is integrated,
the array of electrodes is integrated on the surface of the radiant panel or between the support and the partially resistive conductive material,
the partially resistive conductive material is paint comprising carbon particles and/or metal particles,
the support has a substantially rectangular, square, trapezoidal or circular shape or any other shape allowing it to be integrated into the passenger compartment of the vehicle,
an electrical potential may be applied to just one end of each electrode or to each of the ends of each electrode,
the radiant panel is configured such that at least two arrays of electrodes are installed on two opposite sides of said radiant panel,
the radiant panel may have a substantially planar form,
the radiant panel may take the form of a concave or convex surface or any other more complex form that makes it easier to integrate into the vehicle.

Another subject of the invention is a radiant panel intended to be installed inside a vehicle passenger compartment, in particular a motor vehicle passenger compartment, said radiant panel comprising at least one array of electrodes with at least two primary electrodes of different polarities, the array of electrodes being arranged such that at least one of the primary electrodes is surrounded on either side, at least locally, by dissipative regions capable of generating heat through the flow of an electric current flowing through said at least one primary electrode.

According to one or more features that may be implemented alone or in combination, there may be provision for the following:
there are 2, 3, 4, or more primary electrodes,
the primary electrodes extend parallel to one another,
the primary electrodes are substantially rectilinear,
the primary electrodes are of substantially the same length,
the primary electrodes of opposite polarities are arranged alternately with respect to one another,
the primary electrodes are equidistant from one another,
some primary electrodes are closer to some primary electrodes of different polarities, or by contrast further away from some primary electrodes of different polarities,
the primary electrodes are flowed through by electric currents of different strengths,
the primary electrodes have a constant cross section over their length,
the primary electrodes have a variable cross section over their length,
the primary electrodes have identical cross sections,
the primary electrodes have different cross sections,
the primary electrodes are parallel and aligned,
the primary electrodes are parallel and offset with respect to one another,
at least one of the primary electrodes has at least two complementary branches,
the at least two complementary branches branch off from said primary electrode starting from an identical junction point,
the at least two complementary branches branch off from said primary electrode starting from a different junction point,
there are 1, 2, 3, or more junction points,
the junction points are spaced regularly from one another along at least one primary electrode,
the junction points are spaced irregularly from one another along at least one primary electrode,
the at least two complementary branches are substantially circular arcs,
the circular arcs are concentric,
the at least two complementary branches are formed from n′ straight segments,
n′ may take the following values: 2, 3, 4 or more,
the angle α between two consecutive straight segments is less than 90°, greater than 90° or equal to 90°,
some complementary branches are circular arcs, while others are straight segments,
the complementary branches of different polarities are arranged alternately with respect to one another,
each complementary branch of at least one primary electrode is equidistant from the complementary branches of at least one primary electrode of different polarity,
the complementary branches of different polarities are at a variable distance from one another,
at least one of the complementary branches comprises at least one dissipating branch, in particular a plurality of dissipating branches, designed to produce electric current that flows between said dissipating branch and a complementary branch of different polarity,
at least one of the complementary branches comprises a plurality of dissipating branches of the same polarity,
the dissipating branches are arranged substantially perpendicular to the complementary branches of the same polarity,
at least one of the dissipating branches of the at least one complementary branch is arranged between two neighboring dissipating branches of a complementary branch of different polarity, such that the electric current is able to be established between the dissipating branch of the at least one complementary branch and the two neighboring dissipating branches of a complementary branch of different polarity,
the primary electrodes of different polarities are arranged such that their ends connected to an electric power source are located on the same side of the radiant panel,
the primary electrodes of different polarities are arranged such that their ends connected to an electric power source are located on two opposing sides of the radiant panel,
the primary electrodes have a constant cross section,
the primary electrodes have a variable cross section.

Another subject of the invention is a vehicle passenger compartment, in particular a motor vehicle passenger compartment, comprising a radiant panel as defined above.

The invention will be better understood and further details, features and advantages of the invention will become apparent from reading the following description, given by way of non-limiting example and with reference to the appended drawings, in which:

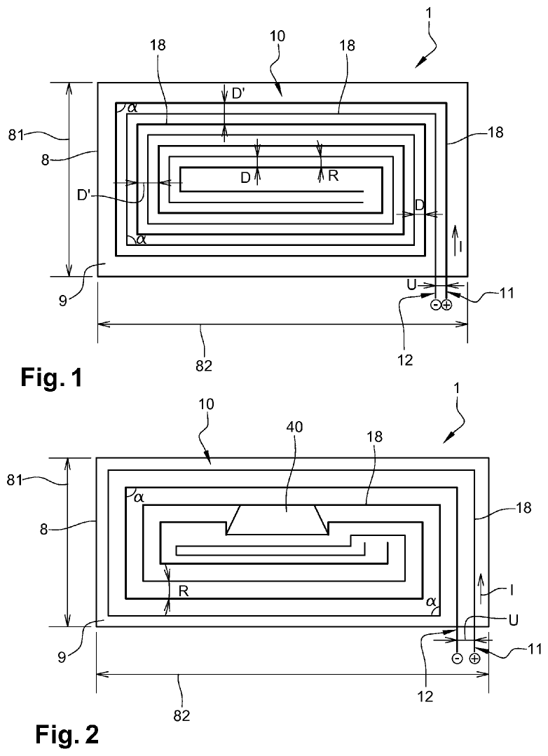

FIG. 1 schematically illustrates a front-on view of a radiant panel according to the present invention and according to a first embodiment,

FIGS. 2, 3 and 4 schematically illustrate variants of the radiant panel from FIG. 1,

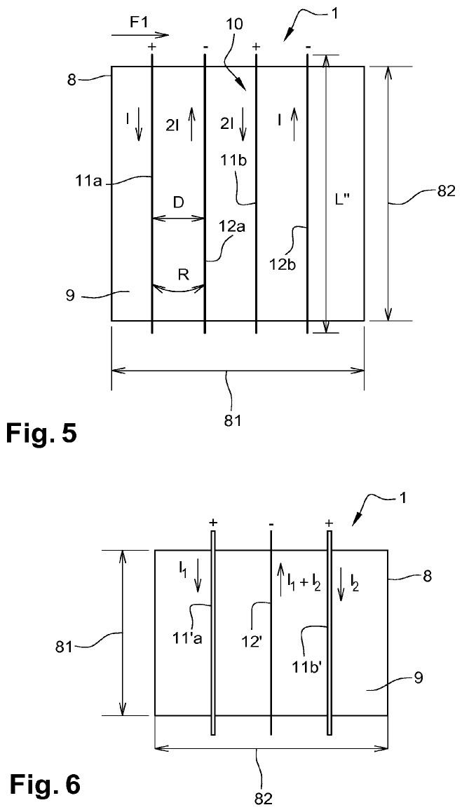

FIG. 5 schematically illustrates a front-on view of a radiant panel according to the present invention and according to a second embodiment,

FIG. 6 schematically illustrates a variant of the radiant panel from FIG. 5,

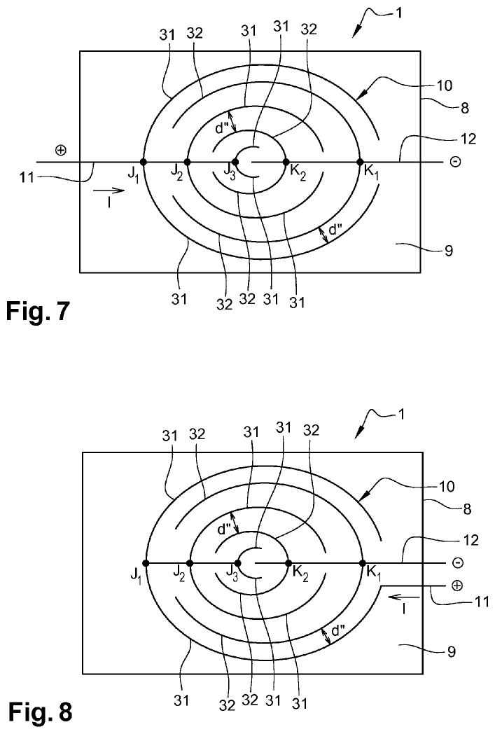

FIG. 7 schematically illustrates a front-on view of a radiant panel according to the present invention and according to a third embodiment,

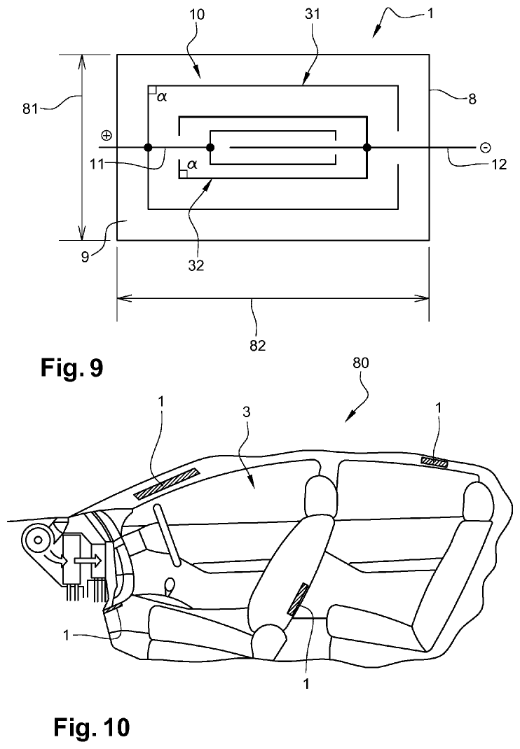

FIGS. 8 and 9 schematically illustrate a variant of the radiant panel from FIG. 7,

FIG. 10 is a sectional view of a motor vehicle passenger compartment equipped with a radiant panel according to the present invention.

It should be noted that the figures explain the invention in detail in order to implement the invention, it being of course possible for said figures to serve to better define the invention if necessary.

FIG. 1 shows a radiant panel 1 comprising a support 8 covered with an electrically conductive coating 9, of uniform thickness, on the surface of the panel, and into which an array 10 of electrodes is integrated. The electrically conductive coating 9 may be for example a layer of paint comprising carbon particles and/or metal particles. The array 10 of electrodes of the radiant panel 1 is arranged as follows: two primary electrodes 11, 12 of different polarities each define a spiral substantially matching the dimensions of the radiant panel 1. Each of the primary electrodes 11, 12 is connected to an electrical supply network of the vehicle that is capable of delivering an electric current of strength I and a voltage U that is applied between the first electrode 11 and the second electrode 12. The primary electrodes 11, 12 are thus configured so as to supply electric current to the electrically conductive coating and thus provide heat through the Joule effect. They may be obtained for example through screen printing or through the adhesive bonding of strips consisting at least partially of conductive material to the support 8.

The support 8 is advantageously in the shape of a rectangle having a short side 81 and a long side 82. In the example illustrated in FIG. 1, the chosen support is in the shape of a rectangle having a short side 81 and a long side 82.

The invention is not limited to the primary electrodes 11, 12 being parallel to the short side 81 and to the long side 82. Specifically, the electrodes may be arranged with the whole of the array 10 being pivoted about a certain angle defined with respect to the sides of the support 8 of the radiant panel 1. The electrodes 11, 12 might thus not be parallel to the sides of the support 8 of the radiant panel 1. Moreover, if the panel has a trapezoidal shape, each of the electrodes 11 and 12 may have a variable length in order to adapt to changes in the dimensions of the panel.

Of course, depending on the integration requirements for the radiant panel 1, the support 8 may be of any other shape, such as a square or a trapezoidal shape, or any other polygonal shape such as a rectangle, a rhombus, etc.

Moreover, it is possible to make provision for the support 8 to have one or more holes 40 of variable shape and dimension depending on the region of the passenger compartment into which the radiant panel 1 is integrated. It is then necessary to adapt the spirals, defined by the primary electrodes 11, 12, to this additional geometric constraint. In the example illustrated in FIG. 2, the radiant panel 1 comprises a rectangular support 8 having a trapezoidal hole 40. Said hole 40 thus creates an aperture that makes it easier to integrate a function other than heating. The radiant panel 1 in FIG. 2 may for example be integrated into the glove box of a motor vehicle, and thus leave space for a handle for opening the glove box.

In FIG. 1, the spirals defined by the primary electrodes 11, 12 each have a number n=4 of straight segments per turn around the radiant panel 1. In this example, the spirals have the same total number of straight segments, equal to 16 (the spirals each make four turns around the radiant panel 1). The invention is not however limited to this exemplary embodiment. It is thus possible, as in the example illustrated in FIG. 2, to make provision for the spirals to have a different total number of straight segments, as well as a variable number of straight segments per turn, in order to adjust to the geometry of the part, here in particular the presence of the hole 40. Each straight segment forming a primary electrode 11, 12 is preferably arranged parallel to and close to at least one straight segment of the primary electrode 11, 12 of different polarity.

According to the examples illustrated in FIGS. 1 and 2, the angle α formed between two consecutive straight segments belonging to the primary electrodes 11, 12 is equal to 90°. Of course, the invention is not limited to all of the angles α being right angles. Specifically, the primary electrodes 11, 12 may have several angles α of different values, less than or greater than 90°, so as to adapt to changes in the dimensions of the panel. The straight segments forming the primary electrodes 11, 12, according to these two illustrative examples of the invention, are either parallel to the long side 82 or parallel to the short side 81 of the support 8 of the radiant panel 1. It is however possible to design an array of primary electrodes 11, 12 in which the straight segments forming the spirals are not parallel to the short sides 81 or to the long sides 82 of the support 8.

According to FIG. 1, the distance D is measured between a straight segment belonging to the primary electrode 11 and an adjacent straight segment belonging to the primary electrode 12. According to one preferred embodiment, the distance D is constant along the entire length of the primary electrodes 11, 12 and the conductive coating is of uniform thickness over the entire surface of the radiant panel. This locally results in the formation of electric dipoles all having the same resistance R. Specifically, in order to achieve a constant power flux density that makes it possible to achieve uniform comfort, it is necessary to have a constant equivalent resistance between the electrode of polarity + and the electrode of polarity − over the entire surface of the radiant panel.

According to one variant embodiment, the distance D is variable, such that the resistance R may itself also vary locally. Specifically, it will not always be possible, in particular due to geometric and mechanical constraints, to keep a constant distance D. For low voltages, the distance D between the two primary electrodes is limited by the maximum thicknesses of heating material defined by mechanical, process, weight and packaging constraints.

With continuing reference to FIG. 1, the distance D′ is measured between two parallel and consecutive straight segments belonging to the same primary electrode 11 or 12. Preferably, as illustrated in FIG. 1, D′ is constant along the entire length of the primary electrodes 11, 12. According to one variant embodiment, it is possible to make provision for the distance D′ to vary along the primary electrodes 11, 12.

The cross section of the primary electrodes 11, 12 may vary from one electrode to another. As shown in FIG. 2, the cross section of the primary electrode 12 is greater than that of the primary electrode 11, specifically over the entire radiant panel 1. Moreover, the cross section of the primary electrode 12 varies over the entire length of said electrode. Its cross section thus decreases when it approaches the center of the radiant panel 1. By varying the cross section of the primary electrodes as a function of its distance from the connection point, the voltage drops across the terminals of said electrodes are limited. The cross section of the electrodes is furthermore limited by mechanical constraints specific to the radiant panel (size, thickness, etc.).

In some cases, and in particular for geometric reasons, it will be necessary to choose another configuration of primary electrodes 11, 12. FIG. 3 shows one embodiment of the invention in which the primary electrodes 11, 12 each define a spiral formed, over its entire length, of substantially curved portions. The center of the spirals is located substantially in the center of the radiant panel 1. Advantageously, the turns of each of the spirals are equidistant (d being the distance between the turns) from one another (example illustrated in FIG. 3). This geometric figure is an Archimedean spiral. However, it is possible to provide for the distance d to vary: the distance d may thus decrease, or by contrast increase, moving away from the center of the spiral.

According to the example illustrated in FIG. 3, the turns of the spiral of the primary electrode 12 are arranged between the turns of the spiral of the primary electrode 11. A distance L separates the turns of the spiral of the primary electrode 12 and the turns of the spiral of the primary electrode 11, which are both adjacent. The distance L is preferably constant along the entire length of each of the electrodes. This locally results in the formation of electric dipoles all having the same resistance R. As mentioned in the case of primary electrodes consisting of straight segments, a constant distance between the primary electrodes promotes a uniform distribution of the heating through the Joule effect. It is then not necessary to adapt the composition of the paint or the thickness of the layer of paint in order to have a constant resistance R.

According to one variant embodiment, the distance L is variable, such that the resistance R may itself also vary locally. When the distance L is variable, it is always possible to adjust the composition of the paint or the thickness of the layer of paint in order to have a constant resistance R.

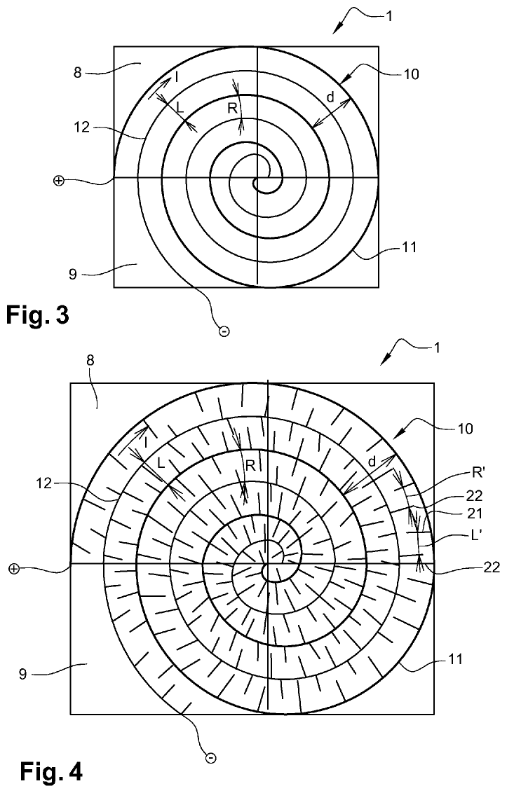

As illustrated in FIG. 4, the primary electrodes 11, 12 may have a plurality of dissipating branches 21, 22 associated respectively with the primary electrodes 11 and 12. The dissipating branches 21 are designed to produce electric current flowing between said dissipating branch 21 and the primary electrode 12 of different polarity that is adjacent thereto. In this example, the dissipating branches 21 are arranged between two neighboring dissipating branches 22 (and vice versa), such that an electric current is able to be established between the dissipating branch 21 and the neighboring dissipating branches 22. In other words, one dissipating branch 21 is interposed between two dissipating branches 22 and one dissipating branch 22 is interposed between two dissipating branches 21. It is then possible to define a pair of electrodes 21, 22 formed of a first dissipating branch 21 and of a second dissipating branch 22, or vice versa. Two adjacent dissipating branches 21, 22 form an electric dipole of resistance R′.

In the example chosen in FIG. 4, the dissipating branches 21 of each of the primary electrodes 11, 12 are arranged substantially perpendicular to the primary electrodes to which they are attached.

In the exemplary embodiment illustrated in FIG. 4, the dissipating branches 21, 22 are regularly spaced along the primary electrodes 11, 12. The distance L′ between two adjacent dissipating branches 21, 22 is preferably constant. Thus, according to the illustrated exemplary embodiment, the pairs of dissipating branches 21, 22 form electric dipoles all having the same resistance R′.

According to one variant embodiment, the adjacent dissipating branches 21, 22 are spaced from one another by a distance L′ that varies from one pair to another, such that the resistance R′ is different from one pair of dissipating branches 21, 22 to another pair of dissipating branches 21, 22.

Thus, by increasing the number of connections within the radiant panel, the voltage drops, which are at the origin of decreasing current densities that impact the heating power flux density, are limited. In the case of a simple circuit without ramifications, the cross section of the primary electrodes may vary as a function of their distance from the connection point in order to limit voltage drops.

According to one variant embodiment of the radiant panel 1 from FIG. 4, the dissipating branches 21, 22 have a variable cross section over their length. Furthermore, said dissipating branches 21, 22 might not have the same cross section depending on the desired technical effects, on the one hand, and on the constraints for integrating the array of electrodes 10 into the radiant panel 1, on the other hand.

FIG. 5 illustrates another embodiment of the present invention. The radiant panel 1 comprises an array 10 of electrodes with four primary electrodes. Two primary electrodes have a polarity + (primary electrodes 11a, 11b) and two primary electrodes have a polarity − (primary electrodes 12a, 12b). The array of electrodes is arranged such that two primary electrodes are surrounded on either side, at least locally, by dissipative regions capable of generating heat through the flow of an electric current flowing through each of these two primary electrodes.

The four primary electrodes (11a, 11b, 12a, 12b) in FIG. 5:
extend parallel to one another,
are substantially rectilinear,
are of substantially the same length L″,
are arranged alternately with respect to one another. Thus, in the direction of the arrow F1 illustrated in FIG. 5, the primary electrode 11a of polarity + is followed by the primary electrode 12a of polarity −, which is followed by the primary electrode 11b of polarity + and then by the primary electrode 12b of polarity −. It is then possible to define three pairs of adjacent primary electrodes of opposing polarities: (11a, 12a), (12a, 11b) and (11b, 12b). The array 10 of primary electrodes preferably comprises a plurality of pairs of primary electrodes of different polarities.

The distance D between a primary electrode 11a, 11b and a primary electrode (12a, 12b) that are both adjacent locally forms an electric dipole of resistance R. According to the exemplary embodiment illustrated in FIG. 5, the distance D is constant between all of the adjacent primary electrodes of opposing polarities.

According to one variant embodiment that is not illustrated, the adjacent primary electrodes of opposing polarities are spaced apart by a distance D that varies from one pair to another. This means that some primary electrodes are closer to some primary electrodes of different polarities, while other primary electrodes are further away from some primary electrodes of different polarities.

In FIG. 5, the primary electrodes 11a, 11b, 12a, 12b are flowed through by electric currents of different strengths. The primary electrodes 11a, 12b, located on two opposite sides of the radiant panel 1, are flowed through by an electric current of strength I, while the primary electrodes 12a, 11b are flowed through by an electric current of strength 21. In other words, by varying the number of primary electrodes within the radiant panel 1, it is possible to locally vary the strength of the electric current I within the panel, and therefore also the heating power within said panel.

FIG. 6 illustrates one variant embodiment of the radiant panel 1 described in FIG. 5, according to which the array 10 is equipped with three primary electrodes 11a′, 12′, 11b′ having different cross sections. The primary electrode 12′ of polarity − is arranged between two primary electrodes 11a′, 11b′ of polarity +. The electric current I₁+I₂ flowing through the electrode 12′ corresponds, in the configuration illustrated in FIG. 6, to the sum of the currents I₁ and I₂ flowing respectively through the primary electrode 11a′ and the primary electrode 11b′.

Thus, by adapting both the number of primary electrodes forming the array 10 of electrodes of the radiant panel 1 and the cross section of each of them, it is possible to modulate the value of the electric current I flowing through them.

Each of the primary electrodes described in FIGS. 5 and 6 has at least one end electrically connected to an electric power source capable of delivering an electric current of a certain strength.

The radiant panel 1 illustrated in FIGS. 5 and 6 comprises a support 8 covered with an electrically conductive coating 9 into which the array 10 of primary electrodes is integrated.

According to FIG. 7, the radiant panel 1 comprises an array 10 of electrodes with two primary electrodes 11, 12 of different polarities +/−. In the chosen configuration, the primary electrodes 11, 12 are:
substantially rectilinear,
arranged parallel to one another,
arranged in the extension of one another, that is to say that the end of the primary electrode 11 is located facing the end of the primary electrode 12.

In the example illustrated in FIG. 7, the primary electrode 11 comprises six complementary branches 31. It is possible to define three pairs of complementary electrodes 31 branching off from the primary electrode 11 starting from an identical junction point Jᵢ located on the primary electrode 11. In the exemplary embodiment shown in FIG. 7, the three pairs of complementary electrodes 31 make it possible to define a sequence of three junction points J₁, J₂ and J₃ that are regularly spaced from one another along the primary electrode 11. The primary electrode 12 in turn has four complementary branches 32. It is possible to define two pairs of complementary electrodes 32 branching off from the primary electrode 12 starting from an identical junction point Kᵢ located on the primary electrode 12. The two pairs of complementary electrodes 32 make it possible to define a sequence of two junction points K₁, K₂ that are regularly spaced from one another along the primary electrode 12.

The invention is not limited to the primary electrodes 11 and 12 having six and four complementary branches, respectively. Specifically, the primary electrodes 11 and 12 may have more complementary branches, or by contrast fewer complementary branches than in the example illustrated in FIG. 7, depending on the dimensional constraints of the panel. This makes it possible to reduce the distance between the electrodes or to better cover the surface.

In FIG. 7, the complementary branches 31 and 32 are:
substantially circular arcs,
concentric,
separated from one another by a constant distance d″.

In the embodiment of the invention described in FIG. 7, the primary electrodes 11, 12 of different polarities are arranged such that their ends, connected to an electric power source, are located on two opposite sides of the support 8 of the radiant panel 1. However, it is not always possible to achieve such a configuration, in particular when there are constraints for integrating the radiant panel 1 into the passenger compartment of the vehicle. Thus, in one variant embodiment described in FIG. 8, the primary electrodes 11, 12 of different polarities are arranged such that their ends, connected to an electric power source, are located on the same side of the support 8 of the radiant panel 1.

According to the variant embodiment shown in FIG. 9, each of the complementary branches 31, 32 is formed from n′=3 straight segments. The adjacent straight segments form right angles α with one another.

According to one variant embodiment that is not illustrated, the complementary branches 31 and 32 may have a plurality of dissipating branches designed to produce electric current that flows between said dissipating branch and the primary electrode 31, 32 of different polarity that is adjacent thereto. The dissipating branches may be arranged between two neighboring dissipating branches (and vice versa), such that an electric current is able to be established between the dissipating branch and the two neighboring dissipating branches of different polarities. The dissipating branches of each of the primary electrodes 11, 12 are preferably arranged substantially perpendicular to the complementary branches 31 and 32 to which they are attached.

According to another variant embodiment that is not shown, it is possible to choose complementary branches having circular arc portions and straight segment portions.

FIG. 10 illustrates one example of integrating radiant panels 1 as described above into a passenger compartment 3 of a motor vehicle 80. The radiant panels 1 are distributed in the passenger compartment 3 in order to locally generate heat in the direction of the regions intended to be occupied by one or more users of the motor vehicle 80. According to the exemplary embodiment illustrated in FIG. 10, the radiant panels 1 are placed on different inside surfaces of the passenger compartment 3, such as the roof of the vehicle, the window pillars, a bottom part of the dashboard such as the footwell, or even the backs of the seats. Of course, other inside surfaces could be equipped with radiant panels 1 depending on the configuration of the passenger compartment 3 and/or according to the needs of the users of the vehicle 80, such as the floor of the vehicle or the walls of the doors. Inside surfaces are understood to mean surfaces facing the regions of the passenger compartment 3 that are occupied by users.

Of course, the features, variants and different embodiments of the invention may be combined with one another, in various combinations, provided that they are not mutually incompatible or exclusive. In particular, it may be possible to conceive of variants of the invention that comprise only a selection of features described below in isolation from the other features described, if this selection of features is sufficient to confer a technical advantage or to differentiate the invention from the prior art. In particular, all of the variants and all of the embodiments described are able to be combined with one another if there is nothing from a technical perspective preventing this combination.

1. A radiant panel configured to be installed inside a motor vehicle passenger compartment, the radiant panel comprising:
at least one array of electrodes with at least two primary electrodes of different polarities, the array of electrodes being arranged such that at least two primary electrodes of different polarities each define at least one spiral winding around one another.

2. The radiant panel as claimed in claim 1, wherein at least two primary electrodes of different polarities are equidistant from one another over at least part of their length.

3. The radiant panel as claimed in claim 1, wherein at least one of the primary electrodes comprises at least one dissipating branch configured to produce electric current that flows between said at least one dissipating branch and said primary electrode of different polarity.

4. The radiant panel as claimed in claim 3, wherein at least one of the dissipating branches of the at least one primary electrode is arranged between two neighboring dissipating branches of the at least one primary electrode of different polarity, such that the electric current is able to be established between the dissipating branch of the at least one primary electrode and the two neighboring dissipating branches of the at least one primary electrode of different polarity.

5. The radiant panel as claimed in claim 1, wherein at least one of the primary electrodes has a variable cross section or a constant cross section over at least part of its length.

6. A radiant panel configured to be installed inside a motor vehicle passenger compartment, said radiant panel comprising:
at least one array of electrodes with at least two primary electrodes of different polarities, the array of electrodes being arranged such that at least one of the primary electrodes is surrounded on either side, at least locally, by dissipative regions capable of generating heat through the flow of an electric current flowing through said at least one primary electrode.

7. The radiant panel as claimed in claim 6, wherein the primary electrodes extend parallel to one another.

8. The radiant panel as claimed in claim 6, wherein the primary electrodes of opposite polarities are arranged alternately with respect to one another.

9. The radiant panel as claimed in claim 6, wherein the primary electrodes are equidistant from one another.

10. The radiant panel as claimed in claim 6, wherein the primary electrodes are flowed through by electric currents of different strengths.

11. The radiant panel as claimed in claim 6, wherein the primary electrodes are parallel and aligned or are parallel and offset with respect to one another.

12. The radiant panel as claimed in claim 6, wherein at least one primary electrode has at least two complementary branches.

13. The radiant panel as claimed in claim 12, wherein the two complementary branches branch off from said primary electrode starting from an identical or different junction point.

14. The radiant panel as claimed in claim 12, wherein the two complementary branches are formed from n′ straight segments.

15. The radiant panel as claimed in claim 12, wherein the two complementary branches are substantially circular arcs.

16. The radiant panel as claimed in claim 15, wherein each complementary branch of at least one primary electrode is equidistant from the complementary branches of at least one primary electrode of different polarity.

17. The radiant panel as claimed in claim 12, wherein at least one of the complementary branches comprises a plurality of dissipating branches configured to produce electric current that flows between said dissipating branch and a complementary branch of different polarity.

18. The radiant panel as claimed in claim 17, wherein at least one of the dissipating branches of the at least one complementary branch is arranged between two neighboring dissipating branches of a complementary branch of different polarity, such that the electric current is able to be established between the dissipating branch of the at least one complementary branch and the two neighboring dissipating branches of a complementary branch of different polarity.

19. A motor vehicle passenger compartment, comprising a radiant panel including at least one array of electrodes with at least two primary electrodes of different polarities, the array of electrodes being arranged such that at least two primary electrodes of different polarities each define at least one spiral winding around one another.
